(19) United States
(12) Patent Application Publication
(10) Pub. No.: US 2010/0279518 A1
(43) Pub. Date: Nov. 4, 2010

(54) ELECTRONIC HUB

(75) Inventors: Henry Watanabe, Lake Forest, CA (US); David Jeromy Penrice, Trabuco Canyon, CA (US)

Correspondence Address: STOEL RIVES LLP - SLC, 201 SOUTH MAIN STREET, SUITE 1100, ONE UTAH CENTER, SALT LAKE CITY, UT, 84111, US

(73) Assignee: TARGUS GROUP INTERNATIONAL, INC., Anaheim, CA (US)

(21) Appl. No.: 12/433,692

(22) Filed: Apr. 30, 2009

(51) Int. Cl. H01R 13/44; H01R 13/60; H01R 13/72

(52) U.S. Cl. 439/40; 439/136; 439/501

(57) ABSTRACT

Disclosed herein are embodiments on an electronic hub configured to connect electronic devices. In certain embodiments, an electronic hub has a first configuration in which various inputs and outputs are covered and are not available for connecting to other devices. In a second configuration the various inputs and outputs are exposed and are available to connect to electronic devices. In certain embodiments, a cable may wrap around a hub body in the first configuration, thus covering the ports when not in use. In other embodiments, the ports may be disposed within a moveable member. In a first configuration, one or more ports in the moveable member may be covered, while in the second configuration, the moveable member may be moved to expose the one or more ports. Certain embodiments include a reset button that is operable to reset an electronic device connected to the hub.

### TECHNICAL FIELD

The present disclosure relates to an electronic hub having one or more inputs and one or more outputs, which in operation connects two or more electronic devices.

### BRIEF DESCRIPTION OF THE DRAWINGS

FIG. 1A is a perspective view of one embodiment of an electronic hub with a cable wrapped around the electronic hub.

FIG. 1B is a top view of the electronic hub of FIG. 1A.

FIG. 1C is a side view of the electronic hub of FIG. 1A.

FIG. 1D is a top view of the electronic hub of FIG. 1A, in which the cable is partially unwrapped from around the electronic hub.

FIG. 1E is a side view of the electronic hub of FIG. 1A, in which the cable is partially unwrapped from around the electronic hub.

FIG. 2A is a perspective view of one embodiment of an electronic hub with a cable wrapped around the electronic hub and forming a loop.

FIG. 2B is a top view of the electronic hub of FIG. 2A.

FIG. 2C is a side view of the electronic hub of FIG. 2A.

FIG. 2D is a top view of the electronic hub of FIG. 2A, in which the cable is partially unwrapped from around the electronic hub.

FIG. 2E is a side view of the electronic hub of FIG. 2A, in which the cable is partially unwrapped from around the electronic hub.

FIG. 3A is a perspective view of one embodiment of an electronic hub with a gasket disposed around the perimeter of the electronic hub.

FIG. 3B is a top view of the electronic hub of FIG. 3A.

FIG. 3C is a side view of the electronic hub of FIG. 3A.

FIG. 3D is a top view of the electronic hub of FIG. 3A, in which the gasket is moved away from the electronic hub and a cable is partially unwrapped from around the electronic hub.

FIG. 3E is a side view of the electronic hub of FIG. 3A, in which the gasket is moved away from the electronic hub and the cable is partially unwrapped from around the electronic hub.

FIG. 4A is a perspective view of one embodiment of an electronic hub with a moveable member, and in which the moveable member is in a closed configuration.

FIG. 4B is a top view of the electronic hub of FIG. 4A.

FIG. 4C is a bottom view of the electronic hub of FIG. 4A.

FIG. 4D is a top view of the electronic hub of FIG. 4A, illustrating the position of a plurality of ports disposed within the moveable member.

FIG. 4E is a side view of the electronic hub of FIG. 4A, in which the moveable member is in an open configuration.

FIG. 4F is a side view of the electronic hub of FIG. 4A, illustrating that the moveable member moves between the open configuration and the closed configuration.

### DETAILED DESCRIPTION OF PREFERRED EMBODIMENTS

Disclosed herein are embodiments of an electronic hub having one or more upstream ports and one or more downstream ports. Upstream ports and downstream ports are generically referred to herein as ports. An electronic hub may be operable to connect devices using a variety of physical connections, including but not limited to Universal Serial Bus (USB), IEEE 1394 (Firewire), Ethernet, eSata, HDMI, DVI, VGA, and the like. Ports may be bi-directional or unidirectional, and may be male or female. The one or more upstream ports connect to a host, while the downstream ports connect to a wide range of electronic devices. For example, an upstream port may be utilized to connect to a computer, while a downstream port may be utilized to connect to computer mice, keyboards, disk drives, cameras, microphones, printers, scanners, music players, video players, cellular phones, modems, network adapters, video displays, and the like. An electronic hub according to the present disclosure may be powered by its own power supply, or may draw power from an upstream port. In certain embodiments having more than one downstream port, data from an upstream port may be mirrored or split between the downstream ports. In other embodiments having more than one downstream port, data may be selectively routed or switched from an upstream port to one or more downstream ports.

In certain embodiments, an electronic hub has a first configuration in which various inputs and outputs are covered and are not available for connecting to other devices. In a second configuration, the various inputs and outputs are exposed and are available to connect to electronic devices. In certain embodiments, a cable may wrap around a hub body in the first configuration, thus covering the ports when not in use. In other embodiments, a gasket may be used to cover the ports in the first configuration. In still other embodiments, the ports may be disposed within a moveable member. In the first configuration, the ports in the moveable member may be covered, while in the second configuration, the moveable member may be moved to expose the ports. Covering or concealing ports when not in use may serve to protect the ports from foreign objects (e.g., dirt and debris), and may enhance the portability of the electronic hub. In various embodiments, covering and uncovering the ports may also include cable management features.

Certain embodiments disclosed herein include a reset button that is operable to reset an electronic device connected to the hub. The reset button may be easily accessible and may be operated without the aid of a tool. In one embodiment, the reset button is disposed on either the top surface or the bottom surface of the body of the electronic hub. The reset button may be associated with a timer or a delay circuit that is operable to only reset a device if the reset button is held down for a particular length of time (e.g., 2 seconds). In certain embodiments, resetting a device may break the electrical connection between the host and a device connected to the electronic hub. In other embodiments, the reset functionality may be implemented using control signals.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. In particular, an “embodiment” may be a system, an article of manufacture (such as a computer readable storage medium), a method, and a product of a process.

The phrases “coupled to,” “connected to,” and “in communication with” refer to any form of interaction between two or more entities, including mechanical, electrical, magnetic, and electromagnetic interaction. Two components may be connected to each other even though they are not in direct contact with each other and even though there may be intermediary devices between the two components.

Furthermore, the described features, structures, or characteristics may be combined in any suitable manner in one or more embodiments. Those skilled in the art will recognize that the teachings of the present disclosure can be practiced without one or more of the specific details, or with other methods, components, materials, etc. In other instances, well-known structures, materials, or operations are not shown or are not described in detail to avoid obscuring aspects of the present disclosure.

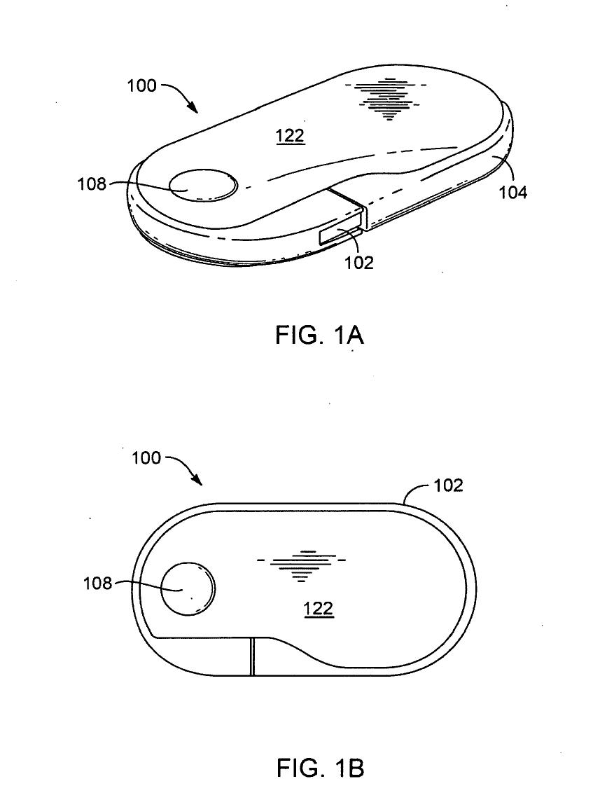

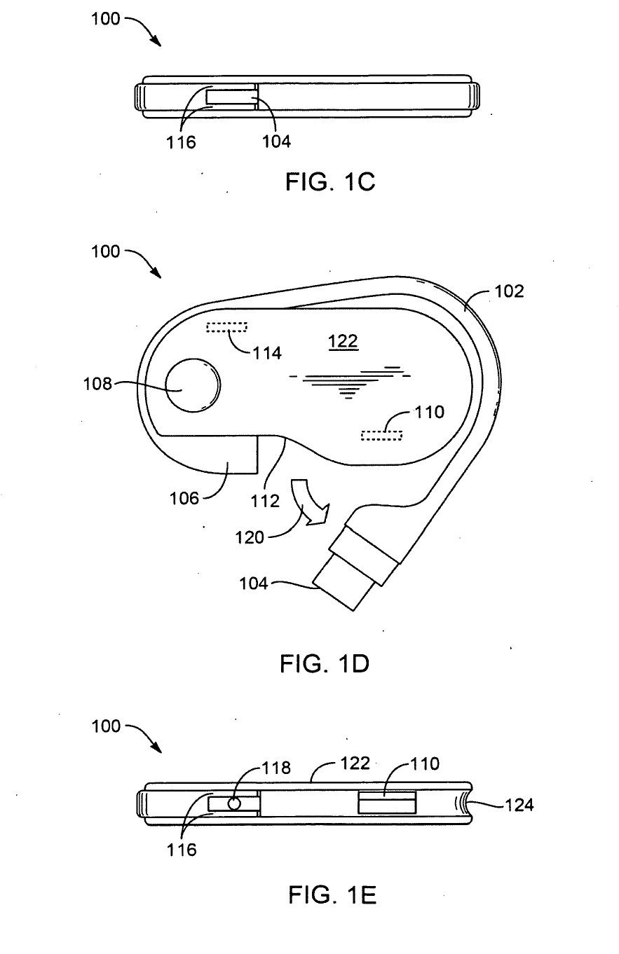

With reference to the accompanying drawings, FIGS. 1A, 1B, 1C, 1D, and 1E illustrate an embodiment of an electronic hub 100 having three USB ports 104, 110, and 114. Port 104 is a male port, while ports 110 and 114 are female ports. Port 104 may be referred to as an upstream port, while ports 110 and 114 are referred to as downstream ports. Port 104 may be used to connect to a computer, while ports 110 and 114 are each configured to connect to a downstream USB device. In the illustrated embodiment, electronic hub 100 allows a computer with one available USB port to connect to two USB devices using ports 110 and 114. Port 104 is connected to one end of a cable 102, which in a first configuration, is wrapped around the body 122 of electronic hub 100. Ports 110, 114 are disposed on the side of body 122. In alternate embodiments, additional ports may also be disposed on body 122.

Electronic hub 100 contains electronic circuitry (not shown) to enable communication of electronic data between ports 104, 110, and 114. In one embodiment, data received from port 104 is transmitted to ports 110 and 114, while data received from ports 110 and 114 is transmitted only to port 104. In this way, data transmitted from a host (e.g., a computer) is received by all devices connected to hub 100, and data sent by a connected device is transmitted to the host, but not to other connected devices.

FIGS. 1A, 1B, and 1C illustrate electronic hub 100 in a first configuration in which ports 104, 110, and 114 are not accessible. In the first configuration, cable 102 wraps around a body 122 of electronic hub 100 and covers ports 110 and 114. Cable 102 is configured so that when in the first configuration, cable 102 extends from point 106, wraps around body 122, and port 104 is proximate to point 106. In the first configuration, port 104 is received into an opening 116. In addition to protecting ports 110 and 114, wrapping cable 102 around body 122 also provides a convenient cable management feature.

FIGS. 1D and 1E illustrate an electronic hub in a second configuration in which ports 104, 110, and 114 are accessible. As illustrated in FIG. 1D, port 104 may move as indicated by arrow 120. Cable 102 may be unwound from around electronic hub 100. Cable 102 may be permanently connected at point 106 to body 122. As illustrated in FIG. 1E, opening 116 may include a magnet 118 for releasably securing port 104 in the first configuration. Magnet 118 attracts a portion of port 104, and thereby secures port 104 in the first configuration. In alternate embodiments, alternate structures may be used to secure port 104 in the first configuration, such as a latch or clasp.

FIG. 1D illustrates that body 122 may be contoured to accommodate port 104. As illustrated, a recess 112 may be configured to receive port 104 in the first configuration. Similarly, as shown in FIG. 1E, a recessed channel 124 around body 122 may be contoured to accommodate cord 102, which may have an approximately cylindrical shape.

FIGS. 1A, 1B and 1D illustrate a reset button 108, which may be configured to reset devices connected to ports 110 and 114. Reset button 108 may be easily accessible and may be operated without the aid of a tool. For example, reset button 108 may be pressed using a finger (i.e., reset button 108 is finger depressible). Reset button 108 may be associated with a timer or a delay circuit (not shown) that is operable to reset a device connected to ports 110 and 114 only if reset button 108 is pressed for a particular length of time. In one embodiment, the length of time is 2 seconds. Other lengths of time are also contemplated. Reset button 108 may reset both ports 110 and 114, or in alternative embodiments, each port may have a separate reset button that is operable to reset only one port.

Resetting a device using reset button 108 may be functionally equivalent to unplugging a device from port 110 or 114 and then reconnecting the device. Such functionality may provide a user with a convenient way to troubleshoot problems with connected devices by effectively disconnecting and reconnecting a device. Such functionality may, for example, be utilized when a computer enters a sleep mode and a connected device is unresponsive when the computer becomes active.

In certain embodiments, resetting a device using reset button 108 breaks the electrical connection between port 104 and ports 110 and 114. In other embodiments, the reset functionality may be implemented using control signals. For example, electronic hub 100 may receive a reset command, and may transmit the command to a system (e.g., a computer) connected to the electronic hub 100 to eject all devices connected to the electronic hub 100. Various operating systems may include functionality for ejecting or unplugging various hot-swappable electronic devices. This functionality may be invoked by reset button 108 by employing appropriate signaling to communicate to the operating system that the device should be ejected. After the eject command has been implemented, electronic hub 100 may then turn off and then turn back on power to ports 110 and 114.

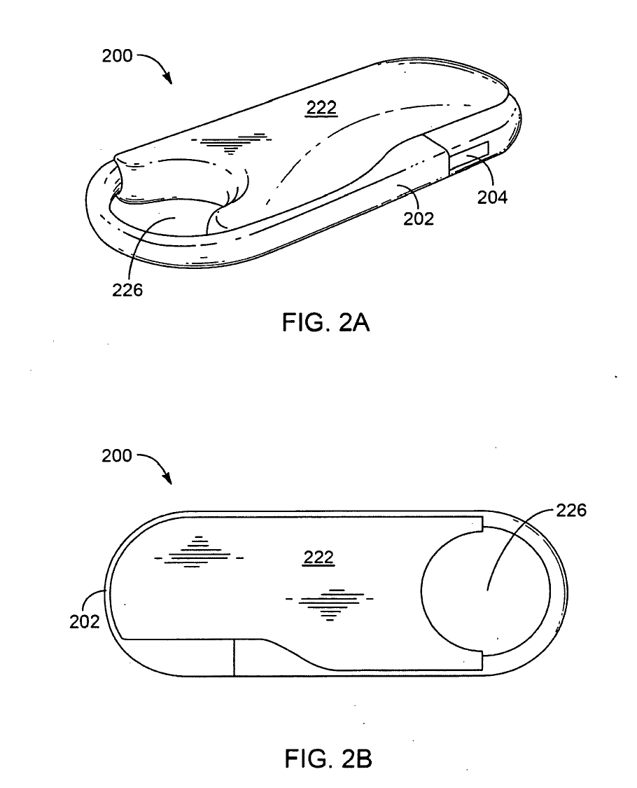

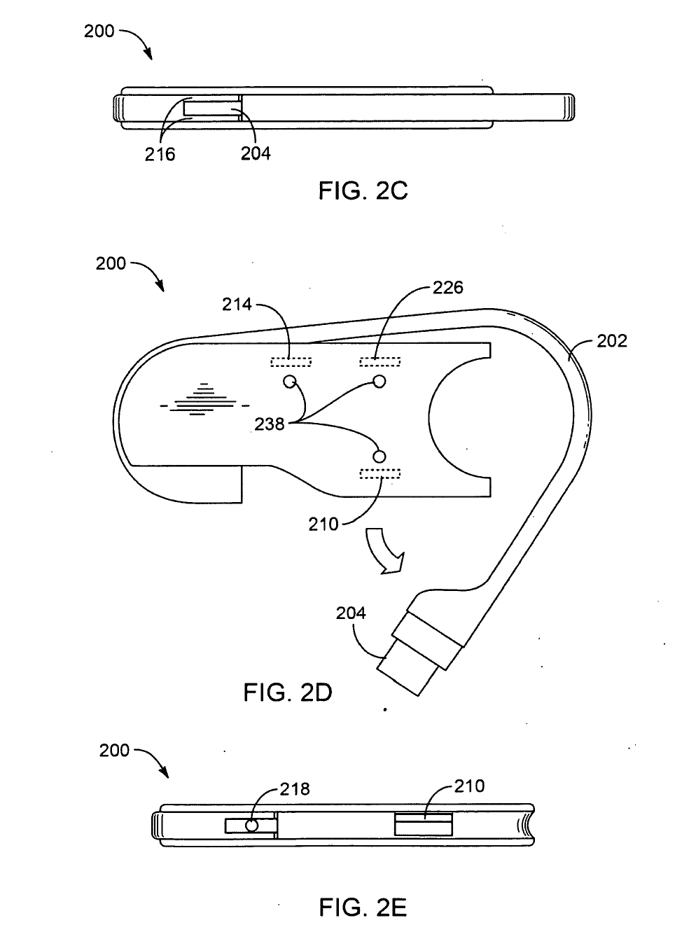

FIGS. 2A, 2B, 2C, 2D, and 2E illustrate an alternate embodiment of an electronic hub 200 in which a cable 202 creates a loop surrounding a space 226. Space 226 may be used to secure electronic hub 200 for enhanced portability. For example, port 204 may be removed from an opening 216, and the loop formed by cable 202 may be secured to another object. For example, electronic hub 200 may be secured to a shoulder strap of a computer carrying case, the handle of a briefcase, the strap of a purse, and the like.

Electronic hub 200 may operate in a similar manner to electronic hub 100 depicted in FIGS. 1A, 1B, 1C, 1D, and 1E. As illustrated in FIGS. 2A, 2B, and 2C, a cable 202 may wrap around a body 222 of electronic hub 200 in a first configuration. In the first configuration, ports 210, 214, and 226 are covered by cable 202. As illustrated in FIGS. 2D and 2E, port 204 may be releasably held in opening 216 by a magnet 218. In a second configuration, cable 202 may be unwrapped from around body 222 to expose ports 210, 214, and 226.

As illustrated in FIG. 2D, a plurality of light sources 238 may be disposed in proximity to ports 210, 214, and 226. The plurality of light sources 238 may be configured to provide a visual indication of activity on ports 210, 214, and 226. The light sources 238 may be turned on when a device is connected to the port (e.g., when devices are connected to ports 210, 214, and 226, light sources 238 will be turned on). The light sources may also be configured to provide a visual indication of activity when data is transmitted via ports 210, 214, and 226 (e.g., the appropriate light source 238 may flash when data is transmitted to a port 210, 214, or 226). In one embodiment, light sources 238 are embodied as light emitting diodes.

As is further illustrated in FIG. 2D, port 210 is located on the opposite side of body 222 from ports 214 and 226. Some devices may have a large connector, which if connected to port 226 may block access to port 214. Conveniently, in the illustrated embodiment, a device having a large connector may be connected to port 210, while standard sized connectors may be connected to ports 214, and 226. In this way, electronic hub 200 may accommodate a large connector using port 210, while still allowing ports 214 and 226 to be used to connect to standard sized connectors. Further, the illustrated embodiment allows electronic hub 200 to maintain a compact design.

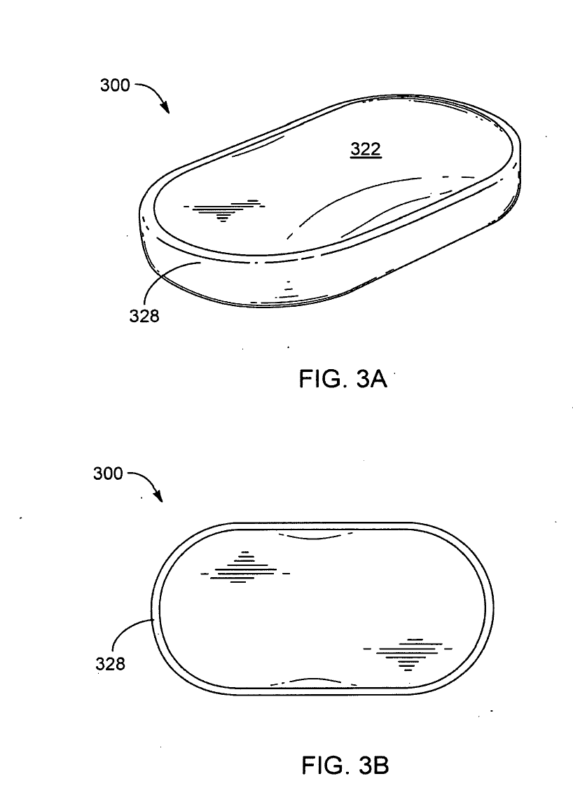

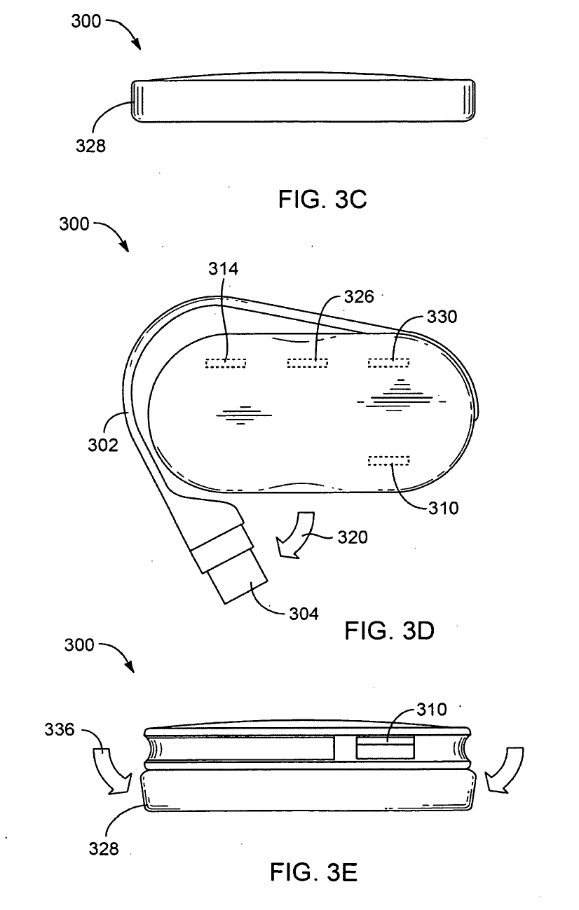

FIGS. 3A, 3B, 3C, 3D, and 3E illustrate an embodiment of an electronic hub 300 in which a gasket 328 is disposed around the perimeter of a body 322. FIGS. 3A, 3B, and 3C illustrate gasket 328 in a first position in which gasket 328 covers a cable 302. Gasket 328 may move as indicated by arrow 336 into a second position, shown in FIG. 3E. With gasket 328 in the second position, a cable 302 may be unwound from around body 322 in the direction shown by arrow 320. Cable 302 may wrap around body 322, similar to the way cable 102 wraps around body 122 of electronic hub 100, shown in FIG. 1. With cable 302 unwound, ports 310, 314, 326, and 330 are exposed, and port 304 is accessible.

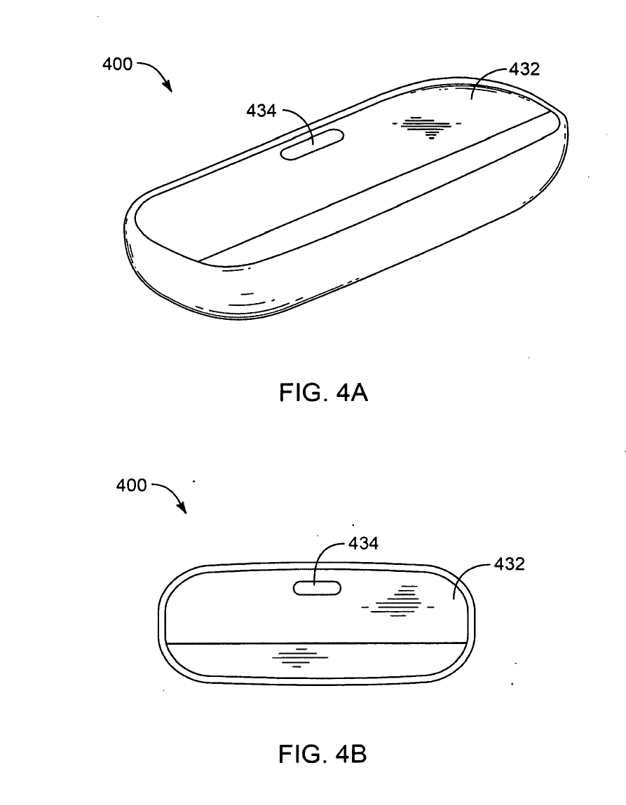

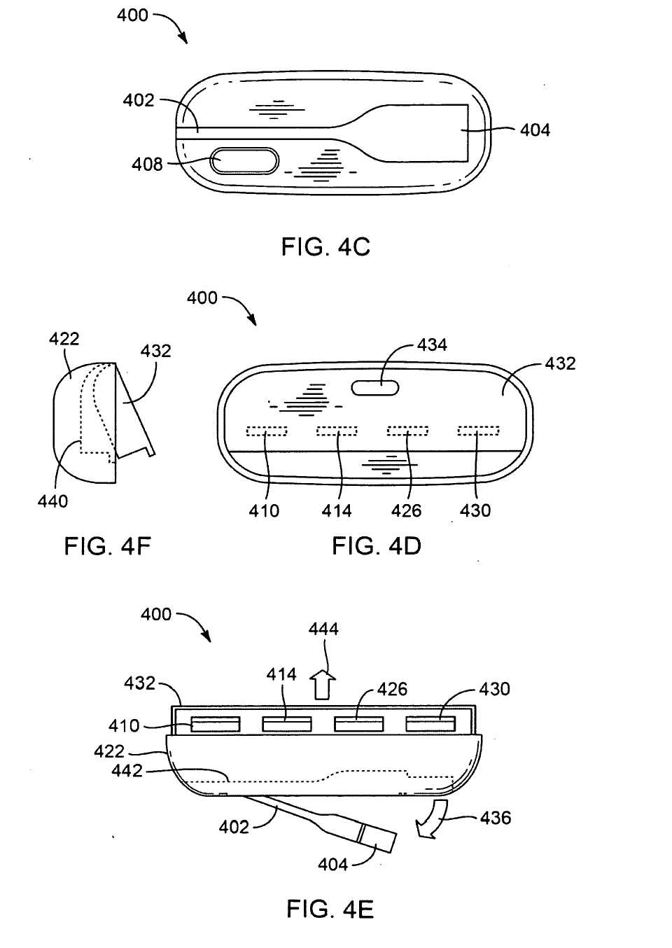

FIGS. 4A, 4B, 4C, 4D, 4E, and 4F illustrate an embodiment of an electronic hub 400 having a moveable member 432. FIGS. 4A, 4B, 4C, and 4D illustrate moveable member 432 in a first configuration in which ports 410, 414, 426, and 430 are not available to be connected to a plurality of electronic devices. In the illustrated embodiment, electronic hub 400 includes a release button 434, which when pressed enables moveable member 432 to move between the first configuration (shown in FIGS. 4A, 4B, 4C, and 4D) and the second configuration (shown in FIGS. 4E and 4F). A reset button 408, shown in FIG. 4C, may also be disposed on the bottom of electronic hub 400. Reset button 408 may operate in a similar manner to reset button 108, shown in FIG. 1.

FIG. 4F illustrates that moveable member 432 may be pivotally or hingedly connected to a body 422. Body 422 may include a first recess 440, shown in FIG. 4F, for receiving moveable member 432 in the first configuration. In moving between the first configuration and the second configuration, moveable member 432 moves in the direction indicated by arrow 444, shown in FIG. 4E. A spring or other biasing member (not shown) may facilitate the movement of moveable member 432 between the first configuration and the second configuration. As illustrated in comparing FIG. 4C to FIG. 4E, a cable 402 connected to a port 404 may be disposed on the bottom of electronic hub 400. A second recess 442 may be disposed along the bottom of body 422 to accommodate cable 402 and port 404. Port 404 and cable 402 may move as indicated by arrow 436.

It will be obvious to those having skill in the art that many changes may be made to the details of the above-described embodiments without departing from the underlying principles of the present disclosure. The scope of the present invention should, therefore, be determined only by the following claims.

1. An electronic hub configured to connect a first electronic device and a second electronic device, the electronic hub comprising:
a body;
a first port configured to connect to the first electronic device, the first port disposed on the body;
a second port configured to connect to the second electronic device; and
a cable connected to the second port and the body, the cable moveable between a first configuration in which the cable at least partially wraps around the body and at least partially covers the first port, and a second configuration in which the first port is exposed.

2. The electronic hub of claim 1, further comprising:
a reset button configured to reset the first port when the reset button is pressed.

3. The electronic hub of claim 2, wherein the reset button is finger depressible.

4. The electronic hub of claim 2, wherein the reset button is configured to only reset the first port after the reset button is continuously pressed for a specified period of time.

5. The electronic hub of claim 4, wherein the specified period of time is approximately 2 seconds.

6. The electronic hub of claim 2, wherein an electrical connection between the first port and the second port is broken when the reset button is pressed.

7. The electronic hub of claim 1, further comprising:
a magnet connected to the body and configured to magnetically couple to the second port when the cable is in the first configuration.

8. The electronic hub of claim 1, further comprising:
a gap formed between at least a portion of the body and at least a portion of the cable when the cable is in the first configuration.

9. The electronic hub of claim 1, further comprising:
a gasket moveable between a first position, in which the gasket at least partially covers the cable when the cable is in the first position, and a second position, in which the gasket does not cover the cable.

10. The electronic hub of claim 9, wherein the gasket comprises an elastomer.

11. The electronic hub of claim 1, wherein the first port comprises a female USB port and the second port comprises a male USB port.

12. The electronic hub of claim 1, wherein the first port comprises a connector selected from the group consisting of USB, and Firewire.

13. The electronic hub of claim 1, further comprising a light source configured to provide a visual indicator of activity on the first port.

14. An electronic hub comprising:
a body;
a first port;
a moveable member pivotally connected to the body and configured to move between a first configuration and a second configuration, the moveable member comprising the first port; and
wherein the first port is covered when the moveable member is in the first configuration, and the first port is not covered when the moveable member is in the second configuration.

15. The electronic hub of claim 14, further comprising a release button enabling the moveable member to pivot between the first configuration and the second configuration when the release button is pressed.

16. An electronic hub configured to connect a first electronic device and a second electronic device, the electronic hub comprising:
a body having a length and a width greater than a thickness, the body comprising:
a first major surface having a length and width approximately equal to the length and width of the body;
a perimeter having a height approximately equal to the thickness of the body;
a first port configured to connect to the first electronic device, the first port disposed on the body;
a second port configured to connect to the second electronic device;
a first reset button configured to reset the first port when the reset button is pressed, the first reset button disposed on the first major surface, and the first reset button configured to be finger depressible.

17. The electronic hub of claim 16, wherein the first reset button is configured to only reset the first port after the reset button is continuously pressed for a specified period of time.

18. The electronic hub of claim 17, wherein the specified period of time is approximately 2 seconds.

19. The electronic hub of claim 16, wherein resetting the first port is functionally equivalent to disconnecting the first electronic device from the first port and reconnecting the first electronic device to the first port.

20. The electronic hub of claim 16, further comprising:
a third port configured to connect to a third electronic device, the third port disposed on the body; and
a second reset button configured to reset only the third port when the second reset button is pressed, the second reset button disposed on the first major surface, and the second reset button configured to be finger depressible.

21. The electronic hub of claim 16, wherein the first port is disposed on the perimeter.

22. The electronic hub of claim 16, wherein the first port comprises a downstream port and the second port comprises an upstream port, and wherein resetting the first device comprises breaking the electrical connection between the first electronic device and the second electronic device.
